(19) United States
(12) Patent Application Publication
(10) Pub. No.: US 2005/0094004 A1
(43) Pub. Date: May 5, 2005

(54) Image taking apparatus

(75) Inventor: Yoshiharu Gotanda, Asaka (JP)

Correspondence Address: BIRCH STEWART KOLASCH & BIRCH, PO BOX 747, FALLS CHURCH, VA, 22040-0747, US

(73) Assignee: Fuji Photo Film Co., Ltd.

(21) Appl. No.: 10/974,702

(22) Filed: Oct. 28, 2004

(30) Foreign Application Priority Data
Oct. 30, 2003 (JP) 2003-370944

(51) Int. Cl. H04N 5/217

(52) U.S. Cl. 348/241

(57) ABSTRACT

An image taking apparatus comprises an angular velocity sensor for detecting a blur of the digital camera, an integration circuit for integrating output signals outputted from the angular velocity sensor during an integration duration associated with a predetermined blur detection duration, a decision circuit for deciding whether an integration result in the integration circuit is over a predetermined threshold, a warning issuing circuit for issuing warning image data representative of a warning image when the integration result is over the predetermined threshold, and a liquid crystal display screen for displaying a warning image together with the subject image, when the integration result is over the predetermined threshold, when the subject image based on the image data obtained through an image taking operation is displayed.

### BACKGROUND OF THE INVENTION

1. Field of the Invention

The present invention relates to an image taking apparatus that catches subject light to perform photography, so that image data representative of a subject image is obtained.

2. Description of the Related Art

As a typical one of the image taking apparatus, there is raised a digital camera which recently comes into wide use. Generally in a camera, a blur of the camera, which will occur at the time of photography, is a problem because the blur causes picture quality of a subject image to be extremely deteriorated. Particularly, in a digital camera, with the advance of miniaturization of the camera and the advance of micro-miniaturization of a solid state imaging device (CCD: Charge Coupled Device) that that catches subject light, the blur of the camera is more severe problems.

In view of the foregoing, as technologies of suppressing the deterioration of a picture quality of a subject image, which will be caused by the blur of the camera, there are proposed, for example, a technology in which an angular velocity sensor is used to detect a blur of a camera at all times, and in the event that a magnitude of the detected blur is a larger than a predetermined magnitude, a release switch is physically fixed, and a technology in which an angular velocity sensor is used to detect a blur of a camera, which will occur at the time of photography, and an exposure starts after the lapse of a predetermined time from the occurrence of the blur (cf. for example, Japanese Patent Application Laid Open Gazette TokuKai Hei. 4-181931 (pages 3 to 14, and FIG. 2)).

At the time of photography, there are various causes of an occurrence of blur of a camera, such as a depression of a release button by an operator, shaking of operator's hand, vibrations of a camera involved in a lens movement at the time of focusing. However, according to the technology disclosed in Japanese Patent Application Laid Open Gazette TokuKai Hei. 4-181931, it is difficult to completely cope with the blur of a camera, which will occur at random owing to the various causes as mentioned above. And thus, it is difficult to completely solve the problem of a deterioration of picture quality of the subject image owing to blur of a camera, which will occur at the time of photograph.

Further, according to the technology in which the release switch is physically fixed in the event that a large blur occurs at the time of photography, the photography is forcibly inhibited. Accordingly, there is a possibility that an operator would lose such a shutter chance that it is wished to take a picture even if a deterioration of picture quality of a subject image would occur.

In the event that the deterioration of picture quality due to the blur of a camera as mentioned above occurs, it is obviously preferable that the operator may recognize the deterioration of picture quality before the photograph is printed. Many of the digital cameras are provided with a crystal display screen, and are so arranged that a subject image based on image data obtained through photography can be displayed on the crystal display screen before the photograph is printed. Accordingly, it would be simply considered that it is possible to display the subject image based on image data obtained through photography on the crystal display screen, and discriminate the deterioration of picture quality before the photograph is printed, and it is possible to do over again taking a picture. However, actually, the liquid crystal display screen is small in size, and an image to be displayed is rough. Accordingly, it is very difficult for an operator to discriminate the deterioration of the picture quality on the liquid crystal display screen. In many cases, such a deterioration of the picture quality will be overlooked at the time of photography, and in future it is only discriminated, when the photograph is printed. As a matter of course, at that time, it is impossible to do over again taking a picture.

Incidentally, in the above description, the problems are explained in conjunction with a digital camera by way of the example. However, the problems are associated with not only the digital camera, but also another image taking apparatus that catches subject light to perform photography, so that image data representative of a subject image is obtained.

### SUMMARY OF THE INVENTION

In view of the foregoing, it is an object of the present invention to provide an image taking apparatus in which an operator can easily know, before printing a photograph, an occurrence of deterioration of a picture quality of a subject image, which will be caused by blur of an image taking apparatus.

To achieve the above-mentioned objects, the present invention provides an image taking apparatus that catches subject light, so that image data representative of a subject image is created, the image taking apparatus comprising:

a blur detection section that detects a blur of the image taking apparatus itself through once image taking operation to obtain a subject image;

a display section having a display screen, which displays on the display screen the subject image based on the image data obtained through the image taking operation; and

a warning section that issues a warning of occurrence of a blur, when the subject image based on the image data obtained through the image taking operation is displayed on the display screen, in the event that a magnitude of the blur detected by the blur detection section at the time of the image taking operation is larger than a predetermined magnitude.

According to the image taking apparatus of the present invention, it is possible for an operator to easily know, by the warning of the warning section when the subject image is displayed before the printing of photography, the fact that a large blur occurred when the subject image is photographed, and in addition to easily know a deterioration of a picture quality of the subject image represented by the image data obtained through the image taking operation. This feature makes it possible for the operator to stop the printing of the photograph or to do over again photography.

In the image taking apparatus according to the present invention as mentioned above, it is preferable that the warning section issues a warning of occurrence of a blur in such a manner that a predetermined warning image is displayed on the display screen, when the subject image based on the image data obtained through the image taking operation is displayed on the display screen, in the event that a magnitude of the blur detected by the blur detection section at the time of the image taking operation is larger than a predetermined magnitude.

The provision of the warning section as mentioned above makes it possible to display the warning image as well as the subject image on the display screen in the event that a large blur occurred at the time of the image taking operation. Thus, it is possible for an operator to easily know the deterioration of picture quality of the subject image, which will occur owing to the blur.

In the image taking apparatus according to the present invention as mentioned above, it is preferable that the display section displays the subject image based on the image data obtained through the image taking operation at time of the end of the image taking operation.

The provision of the display section as mentioned above causes the warning section to issue the warning of the occurrence of the blur, in the event that a large blur occurred at the time of the image taking operation, when the display section displays on the image screen the subject image based on the image data obtained through the image taking operation at time of the end of the image taking operation. This feature makes it possible for an operator to readily know, immediately after the end of the image taking operation, the occurrence of a large blur at the time of the image taking operation and the deterioration of picture quality of the subject image, which will occur owing to the blur. Thus, the operator can avoid missing an opportunity for doing over again photography.

In the image taking apparatus according to the present invention as mentioned above, it is preferable that the image taking apparatus further comprises:

an information attaching section that attaches blur information representative of an occurrence of a blur to the image data obtained through the image taking operation in the event that a magnitude of the blur detected by the blur detection section at the time of the image taking operation is larger than a predetermined magnitude;

a recording section that records the image data onto a predetermined recording medium, and the blur information attached to the image data as well onto the recording medium in the event that the blur information is attached to the image data by the information attaching section; and

a reading section that reads the image data from the recording medium,

wherein the a display section displays on the display screen the subject image represented by the image data read by the reading section from the recording medium, and

the warning section causes a predetermined warning image to be displayed on the display screen, when the subject image based on the image data is displayed on the display screen, in the event that the blur information is attached to the image data read by the reading section from the recording medium.

According to the image taking apparatus of the present invention as mentioned above, in the event that a large blur occurs at the time of image taking operation for the subject image, there are recorded on the recording medium image data representative of the subject image and the blur information as well. When the image data is read from the recording medium and the subject image represented by the image data is displayed on the display screen, the blur information is also read from the recording medium and the warning image is displayed on the display screen together with the subject image. Thus, it is possible for the operator to easily know the deterioration of a picture quality of the subject image, which will be caused by a large blur of the image taking apparatus, when the subject image based on the image data, which is obtained in a state that a large blur occurred, is reproduced on the display screen.

### BRIEF DESCRIPTION OF THE DRAWINGS

FIG. 1 is a perspective view of a digital camera of an embodiment of the present invention, looking from the front wherein a lens is mounted.

FIG. 2 is a rear elevation of the digital camera of the embodiment of the present invention.

FIG. 3 is a functional block diagram showing the digital camera, as shown in FIG. 1 and FIG. 2.

FIG. 4 is a flowchart useful for understanding a process for an image taking processing including a detection of blur in the digital camera and warning to an operator.

FIG. 5 is an illustration showing a warning image displayed on a liquid crystal display screen.

FIG. 6 is a flowchart useful for understanding details of the blur detection processing in the flowchart shown in FIG. 4.

FIG. 7 is a timing chart useful for understanding a detection of blur in the exposure time by an angular velocity sensor.

FIG. 8 is a graph showing a relation between the blur detected by the angular velocity sensor and an output signal from the angular velocity sensor.

FIG. 9 is a timing chart useful for understanding an example in which an amount of blur at the time of photography is determined during a predetermined duration just before the exposure time, in accordance with a blur detected by the angular velocity sensor.

FIG. 10 is a timing chart useful for understanding an example in which an amount of blur at the time of photography is determined during a predetermined duration just before the exposure time, in accordance with a blur detected by the angular velocity sensor.

FIG. 11 is a view showing a file structure of an image file.

FIG. 12 is a table of a predetermined attached information including blur information, which is attached to compressed image data obtained through photography.

FIG. 13 is a flowchart useful for understanding a reproduction processing for a subject image to a liquid crystal display screen.

### DETAILED DESCRIPTION OF PREFERRED EMBODIMENTS

Embodiments of the present invention will be described with reference to the accompanying drawings.

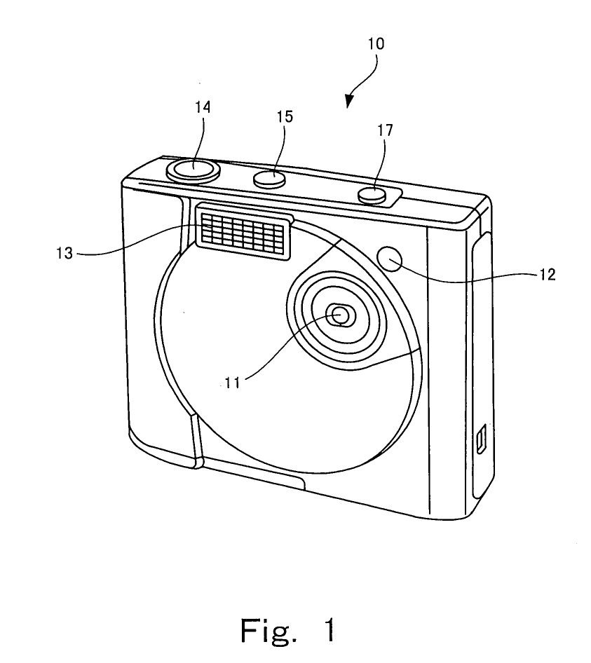

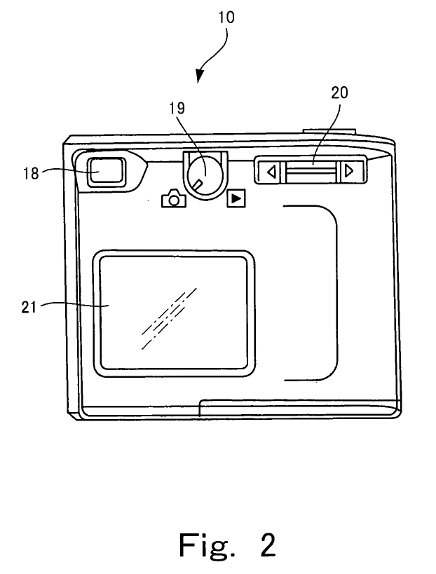

FIG. 1 is a perspective view of a digital camera of an embodiment of the present invention, looking from the front wherein a lens is mounted. FIG. 2 is a rear elevation of the digital camera of the embodiment of the present invention.

On the front of a digital camera 10 shown in FIG. 1, there are provided an image taking lens 11, a finder window 12, and a flashgun 13.

On the top of the digital camera 10, a release switch 14, a power switch 15, and a flash switch 17 that is a handler for changing over between a normal photographic mode and a flash photographic mode.

On the back of the digital camera 10 shown in FIG. 2, there are provided a finder 18, a change over switch 19 for changing over the digital camera 10 between a photographic state and a reproduction state, a zoom switch 20 that is a handler for performing a zoom operation, and a liquid crystal display screen 21 for displaying reproduced still picture and through image. The liquid crystal display screen 21 corresponds to an example of the display screen referred to in the present invention.

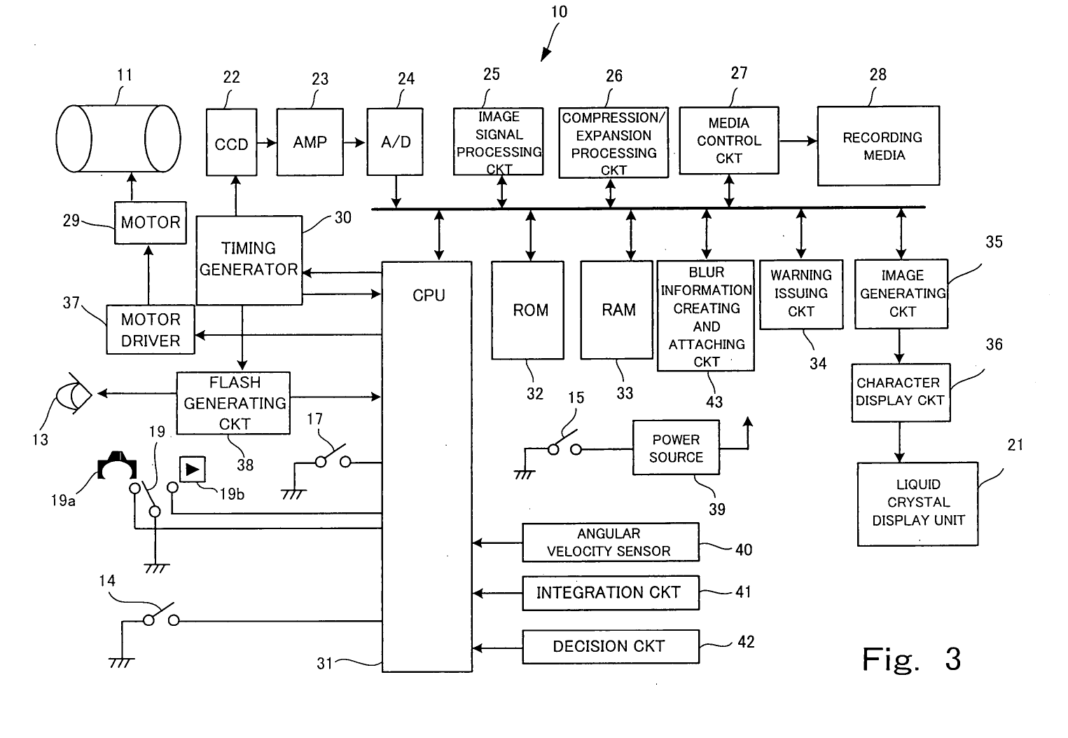

FIG. 3 is a functional block diagram showing the digital camera, as shown in FIG. 1 and FIG. 2.

A ROM 32 stores a control program of the digital camera 10 and a start program for the control program. When an operator depresses the power switch 15 (cf. FIG. 1) so that a power source 39 supplies a power to the digital camera 10, the control program is written from a ROM 32 into a RAM 33 in accordance with the start program. Thereafter, during an operation of the digital camera 10, a CPU 31 accesses the RAM 33 to control the operation of the digital camera 10 in accordance with the control program stored in the RAM 33.

According to the digital camera 10 of the present invention, while the electric power is supplied, a subject image, which is image-formed through the image taking lens 11 on a solid state imaging device (hereinafter it is referred to as a CCD) 22, is displayed on the liquid crystal display screen 21 in form of the through image.

Hereinafter, first, there will be explained an operation of the digital camera 10 from the incidence of subject light into the digital camera 10 up to the display of the through image on the liquid crystal display screen 21 in conjunction with structural elements of the digital camera 10.

The subject light is image-formed on the CCD 22 after passing through the image taking lens 11. A subject image formed on the CCD 22 is subjected to the photoelectric conversion at a predetermined frame rate when a timing generator 30 drives the CCD 22 in accordance with the instruction issued from the CPU 31, so that the CCD 22 outputs an analog image signal.

The analog image signal outputted from the CCD 22 is amplified by an amplifier 23 and then converted into digital image data by an A/D converter 24. The-digital image data is stored in the RAM 33.

The digital image data is read by an image signal processing circuit 25 from the RAM 33 so as to be subjected to an image signal processing. The digital image data subjected to the image signal processing is again stored in the RAM 33.

Thereafter, the digital image data subjected to the image signal processing is read by an image generating circuit 35 from the RAM 33 and is converted into a video signal. In the event that the digital image data includes character information such as photography date and operator's comments, the character information is converted into a signal for video display by a character display circuit 36. Thereafter, the video signal is fed to the liquid crystal display screen 21 so as to be displayed thereon in form of the through image. The image generating circuit 35, the character display circuit 36 and the liquid crystal display screen 21 constitute an example of the display section referred to in the present invention.

Now when an operator puts the digital camera 10 about, the through image displayed on the liquid crystal display screen 21 is changed in structure. Further when the operator operates the zoom switch 20 (cf. FIG. 2), a motor driver 37 drives a motor 29, so that the motor 29 moves the image taking lens 11 to carry out a zooming.

Next, there will be explained an operation of the digital camera 10.

When the change over switch 19 is set, between a marking 19a representative of a photography state and a marking 19b representative of a reproduction state, to the marking 19a representative of the photography state, the digital camera 10 offers the photography state.

In this condition, when the operator slightly depresses (hereinafter it is referred to as a half-depression state) the release switch 14 at the time of obtaining a desired picture image, focusing and exposure amount control are carried out in accordance with an instruction of the CPU 31.

Thereafter when the operator further depresses the release switch 14 from the half-depression state (hereinafter it is referred to as a complete-depression state), the photography is carried out.

After the complete-depression state, a predetermined initial setting such as discharging for the CCD 22 is completed and then the exposure of the subject light onto the CCD 22 is initiated. The CCD 22 receives the subject light during a predetermined exposure time. After the predetermined exposure time lapses, the analog image signal outputted from the CCD 22 is amplified by the amplifier 23 and then converted into digital image data by the A/D converter 24. The digital image data is stored in the RAM 33. The digital image data is read by an image signal processing circuit 25 from the RAM 33 so as to be subjected to an image signal processing. The digital image data subjected to the image signal processing is again stored in the RAM 33.

When the flash switch 17, also shown in FIG. 1, is depressed, so that the digital camera 10 is set to the flash photographic mode, the flashgun 13 is controlled by a flash generating circuit to emit a flash in timing of the beginning of the exposure time.

The digital camera 10 is provided with an angular velocity sensor 40 for detecting a blur of the digital camera 10. According to the digital camera 10 of the present embodiment, after the release switch 14 offers the complete-depression state, the angular velocity sensor 40 detects a blur of the digital camera 10 during a predetermined blur detection duration, which will be described later, and outputs an output signal according to the angular velocity of the blur. An integration circuit 41 integrates output signals outputted from the angular velocity sensor 40 during an integration duration (which will be described later) associated with the predetermined blur detection duration. The integration result is fed to a decision circuit 42 (which will be described later) in form of a blur quantity representative of the magnitude of a blur of the digital camera 10 at the time of photography. The angular velocity sensor 40 and the integration circuit 41 constitute an example of the blur detection section referred to in the present invention.

The blur quantity fed from the integration circuit 41 to the decision circuit 42 is compared with a predetermined threshold in the decision circuit 42. In the event that the decision circuit 42 decides that the blur quantity is over the threshold, it is decided that there occurred, at the time of photography, a large blur affecting the picture quality of the subject image. A blur information creating and attaching circuit 43 creates information representative of the existence of the occurrence of the large blur, as mentioned above, at the time of photography in accordance with the decision result of the decision circuit 42. The blur information creating and attaching circuit 43 reads from the RAM 33 the digital image data subjected to the image signal processing, which is obtained through photograph and is stored in the RAM 33, and attaches the blur information to the digital image data. The digital image data, to which the blur information is attached, is again stored in the RAM 33. The blur information creating and attaching circuit 43 corresponds to an example of the information attaching section.

A compression and expansion circuit 26 reads from the RAM 33 the digital image data, to which the blur information is attached. Only the digital image data portion of the blur information attached digital image data is subjected to a compression processing so as to be converted into compressed image data. Thus, there is completed an image file consisting of the blur information and the compressed image data. A media control circuit 27 records the image file via the RAM 33 onto a recording media 28. The media control circuit 27 corresponds to an example of the recording section referred to in the present invention.

The blur information attached digital image data, which is stored in the RAM 33, is read from the RAM 33 by a warning issuing circuit 34 too. In the event that the blur information, which is attached to the digital image data, is information indicative of the occurrence of a large blur, the warning issuing circuit 34 issues to an image generating circuit 35 warning image data representative of a warning image that warns an operator of the occurrence of a large blur. On the other hand, the image generating circuit 35 and a character display circuit 36 displays on the liquid crystal display screen 21 the subject image based on the digital image data portion of the blur information attached digital image data. In the event that a large blur occurs at the time of photography, and the warning image data is transmitted from the warning issuing circuit 34 to the image generating circuit 35, the warning image based on the warning image data is displayed on the liquid crystal display screen 21 together with the subject image. The warning issuing circuit 34 and the image generating circuit 35 constitute an example of the warning section referred to in the present invention.

According to the digital camera 10 of the present embodiment, it is possible for an operator to confirm the existence of the occurrence of the large blur at the time of photography on the liquid crystal display screen 21 at the time of completion of photography, and in addition to clearly and easily recognize as to whether the subject image, which is now displayed on the liquid crystal display screen 21, is deteriorated in picture quality.

Further, the existence of the occurrence of the large blur at the time of photography is recorded, as mentioned above, on the recording media 28 together with the compressed image data associated with the subject image. According to the present embodiment, an operator can reproduce and display on the liquid crystal display screen 21 the subject image represented by the compressed image data recorded on the recording media 28. At that time, first, the media control circuit 27 reads from the recording media 28 via the RAM 33 an image file associated with the subject image designated by the operator in reproduction and display. The media control circuit 27 corresponds to an example of the reading section referred to in the present invention as well as an example of the recording section referred to in the present invention. The compression and expansion circuit 26 expands the compressed image data of the image file thus read. The subject image according to the digital image data obtained through the expansion is displayed on the liquid crystal display screen 21. In the event that the blur information of the image file indicates the occurrence of a large blur at the time of photography, the warning issuing circuit 34 issues warning image data representative of a warning image in accordance with the blur information. Thus, the warning image, together with the subject image, is displayed on the liquid crystal display screen 21. Thus, it is possible for an operator to confirm the occurrence of a large blur at the time of photography, and in addition the deterioration of picture quality of the subject image owing to the blur.

With the above description there will be terminated the explanation of the structure and the operation of the digital camera 10 of the present embodiment. And hereinafter, there will be explained in detail the detection of the blur in the digital camera 10 at the time of photography, in conjunction with FIG. 1, FIG. 2 and FIG. 3.

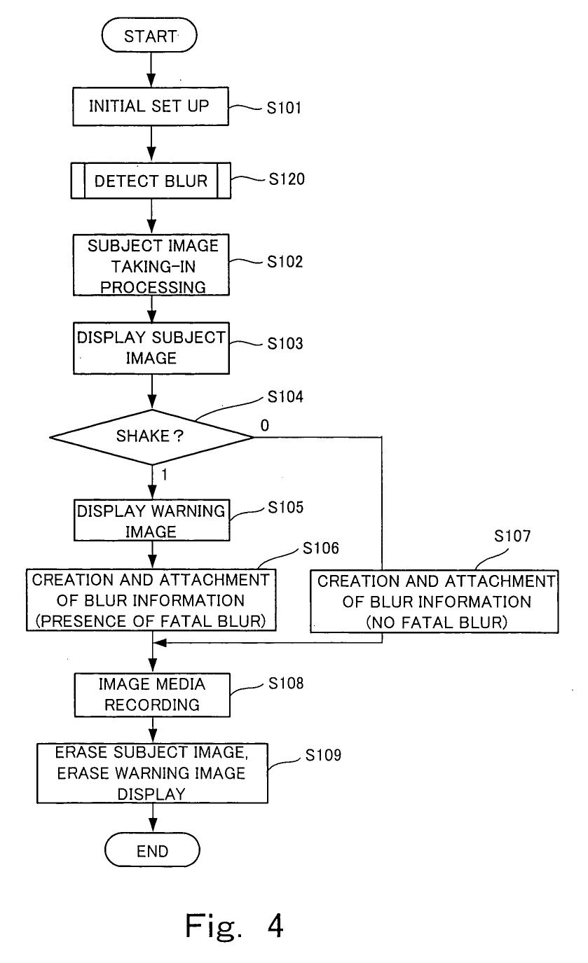

FIG. 4 is a flowchart useful for understanding a process for an image taking processing including a detection of blur in the digital camera and warning to an operator.

The processing of the flowchart shown in FIG. 4 is started, when an operator operates the release switch 14 in the complete-depression.

When the processing is started, as mentioned above, a predetermined initial setting such as discharging for the CCD 22 is carried out (a step S101).

According to the present embodiment, when the initial setting is completed, there is carried out blur detection processing for detecting a blur of the digital camera 10 in the exposure time (a step S120). As will be described later, in the blur detection processing (the step S120), there is computed the blur amount according to the angular velocity detected by the angular sensor 49 within the exposure time in form of a value representative of a magnitude of the blur at the time of photography. In the event that the blur amount is over a predetermined threshold, a variable “SHAKE” is set to “1”. On the other hand, in the event that the blur amount is less than the predetermined threshold, the variable “SHAKE” is set to “0”.

Next, the analog image signal, which is generated by the CCD 22 through exposure onto the CCD 22 over the exposure time, is converted into the digital image data representative of the subject image through the amplifier 23 and the A/D converter 24, as mentioned above. The image signal processing circuit 25 applies a predetermined image signal processing to the digital image data. And thereafter, the image signal processing circuit 25 carries out a subject image taking-in processing in which the blur information consisting of the variables “SHAKE” is applied to the digital image data subjected to the predetermined image signal processing, and then stored in the RAM 33 (a step S102). Next, the digital image data, to which the blur information is attached, is read from the RAM 33, and there is carried out a display of the subject image onto the liquid crystal display screen 21 in accordance with the digital image data portion of the blur information attached digital image data (a step S103).

Next, it is decided as to which one is set between “1” and “0” in the variable “SHAKE” in the information portion of the blur information attached digital image data (a step S104). In this decision processing, when it is decided that the variable “SHAKE” is “1” (“1” in a step S104), as mentioned above, the warning issuing circuit 34 issues warning image data representative of a warning image warning an occurrence of the large blur at the time of photography. The warning image represented by the warning image data is displayed together with the subject image on the liquid crystal display screen 21 (a step S105). Subsequently, the compression and expansion circuit 26 converts into compressed image data the digital image data portion of the blur information attached digital image data, to which the blur information indicating the occurrence of a large blur at the time of photography is attached, the blur information consisting of the variable “SHAKE” that is set to “1”, so that the image file is completed (a step S106).

On the other hand, In the decision processing of the step S104, when it is decided that the variable “SHAKE” is “0” (“0” in a step S104), only the subject image is displayed on the liquid crystal display screen 21. Subsequently, the compression and expansion circuit 26 converts into compressed image data the digital image data portion of the blur information attached digital image data, to which the blur information indicating no occurrence of a large blur at the time of photography is attached, the blur information consisting of the variable “SHAKE” that is set to “1”, so that the image file is completed (a step S107).

Next, the image file, which is created in the step S106 and the step S107, is recorded on the recording media 28 (a step S108). Then, after the lapse of a predetermined time since the display of the subject image on the liquid crystal display screen 21, the subject image is erased from the liquid crystal display screen 21 (a step S109). In the step S109, in the event that the warning image is displayed on the liquid crystal display screen 21, the warning image is also erased.

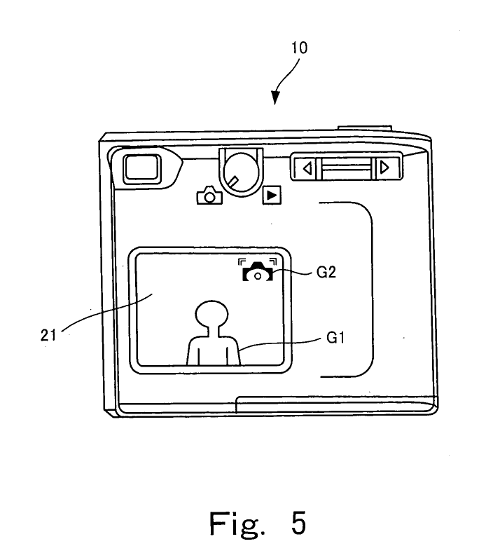

FIG. 5 is an illustration showing a warning image displayed on a liquid crystal display screen.

FIG. 5 shows a rear elevation of the digital camera shown in FIG. 2 too. In FIG. 5, there is shown a state that a subject image G1 is displayed together with a warning image G2 on the liquid crystal display screen 21. According to this feature, it is possible for an operator to easily know, just after photography, or when the subject image G1 photographed in the past is reproduced, the fact that a large blur occurred when the subject image G1 is photographed, through the display of the warning image G2 together with the subject image G1 on the liquid crystal display screen 21, and in addition to easily know a deterioration of a picture quality of the subject image G1, which will be caused by the blur.

Next, there will be explained details of the blur detection processing (the step S120) in the flowchart of FIG. 4.

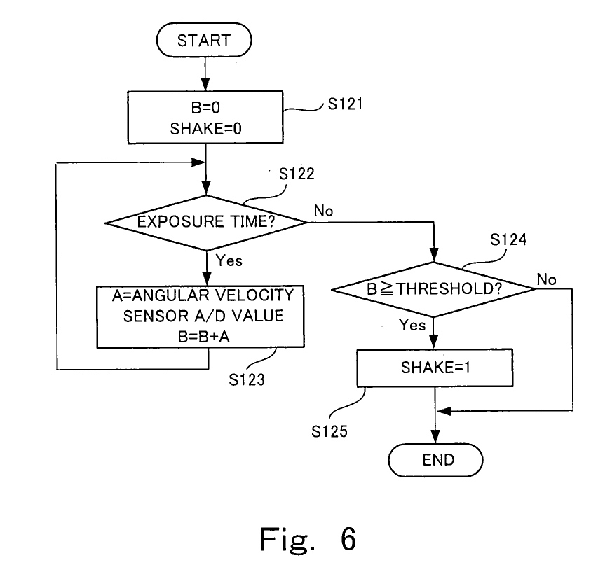

FIG. 6 is a flowchart useful for understanding details of the blur detection processing in the flowchart shown in FIG. 4.

When the blur detection processing starts, first, a variable B representative of the blur amount, and the variable “SHAKE” representative of the existence of a large blur at the time of photography, are reset to “0” (a step S121). Next, it is decided as to whether the present time is concerned with a time point within an exposure time which will be described later (a step S122).

When it is decided that the present time is concerned with a time point within an exposure time (“yes” in the step S122), there is carried out such a computing processing that a value (0+A), wherein a digital signal A is added to the variable B that is reset to “0” in the processing of the step 121, is substituted for the variable B representative of a blur amount at the present time, where A denotes the digital signal, which is obtained through an A/D conversion of an output signal generated from the angular sensor 40, according to an acceleration detected by the angular sensor 40 at that time (a step S123). As will be described later, the angular sensor 40 has a time constant. Accordingly, the angular sensor 40 outputs the output signal according to the angular velocity of the blur after the lapse of a time by the corresponding time constant since the angular sensor 40 detects the blur. What is the present time, which is an object of the decision processing of the step S122, is a time point when the angular sensor 40 detects the blur. What is the digital signal A in the computing processing of the step S123 is a digital signal in which the angular sensor 40 detects the blur at the present time in the decision processing of the step S122, and outputs an output signal after the lapse of a time by the corresponding time constant since the angular sensor 40 detects the blur, and the output signal according to the angular velocity of the blur detected by the angular sensor 40 at the present time is A/D converted.

The computing processing (the step S123) is repeated until it is decided in the processing of the step S122 that the present time is a time point over the exposure time. This repeat makes it possible to compute a blur amount B representative of a magnitude of a blur during the exposure time in such a manner that the output signal outputted from the angular sensor 40 during an integrating duration, which corresponds to the exposure time and is delayed from the exposure time by the corresponding time constant as mentioned above.

In the processing of the step S122, when it is decided that the present time is a time point over the exposure time (No in the step S122), it is decided as to whether the blur amount B, which is obtained in the computing processing of the step S123, is over a predetermined threshold (a step S124).

When it is decided that the blur amount B is over the predetermined threshold (Yes in the step S124), the variable “SHAKE” is set to “1”. When it is decided that the blur amount B is less than the predetermined threshold (No in the step S124), the variable “SHAKE” is set to “0” (step S125).

As mentioned above, according to the present embodiment, the angular sensor 40 detects the blur within the exposure time.

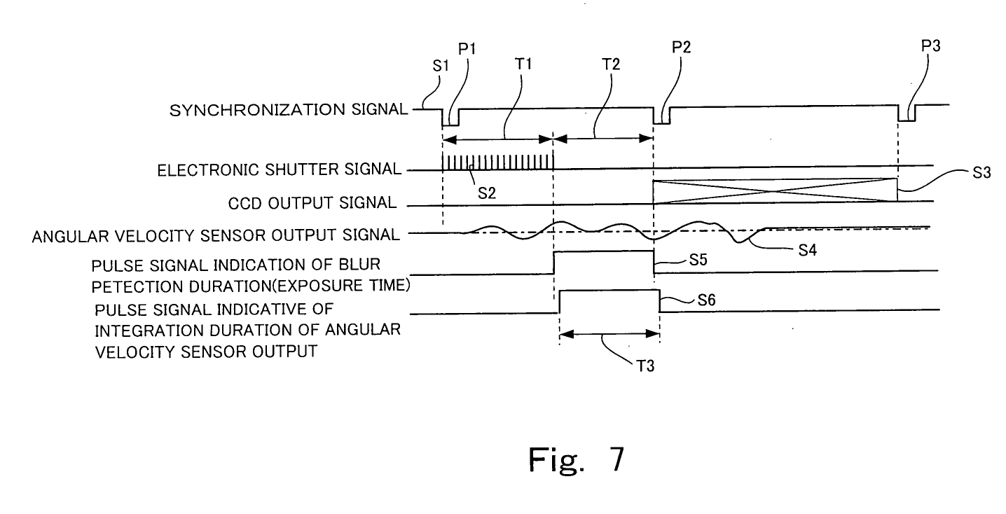

FIG. 7 is a timing chart useful for understanding a detection of blur in the exposure time by an angular velocity sensor.

FIG. 7 typically shows a synchronization signal S1 for controlling a timing of an operation of the respective structural element of the digital camera 10, an electronic shutter signal S2 for controlling an exposure in the CCD 22, an output signal S3 generated from the CCD 22, an output signal S4 generated from the angular sensor 40, a pulse signal S5 indicative of a detection duration of blur in the angular sensor 40, and a pulse signal S6 indicative of an integration duration for the output signal of the angular sensor 40 in the integration circuit 41.

When an operator depresses the release switch 14, there appears a photography start pulse P1 on the synchronization signal S1. During an initial setting duration T1 from the appearance of the photography start pulse P1, an initial setting such as a discharge is applied to the CCD 22. During the initial setting duration T1, pulses appear at regular intervals on the electronic shutter signal S2 so as to inhibit the exposure on the CCD 22. When the initial setting duration T1 is terminated, the pulses on the electronic shutter signal S2 disappear, so that the exposure on the CCD 22 is initiated. This exposure is executed over an exposure time T2 since the pulses on the electronic shutter signal S2 disappears until an exposure terminating pulse P2 appears on the synchronization signal S1. When exposure time T2 is terminated, a voltage, which is charged onto the CCD 22 through the photoelectric conversion in the exposure time T2, is outputted from the CCD 22 in form of an output signal S33. The output from the CCD 22 is continued until a CCD output terminating pulse P3 appears on the synchronization signal S1. The output signal S3 outputted from the CCD 22 consists of signals of various levels to be outputted from pixels constituting the CCD 22 in accordance with the subject image formed on the CCD 22. However, in FIG. 7 the output signal S3 is typically shown as a pulse.

By the way, when an operator depresses the release switch 14, there will occur a blur on the digital camera 10. As mentioned above, the angular velocity sensor 40 detects the blur. The angular velocity sensor 40 outputs an output signal S4 according to the angular velocity of the blur thus detected. FIG. 7 shows a state that the output signal S4 varies in accordance with the variation of the blur occurred by the depression of the release switch 14. The angular velocity sensor 40 has a predetermined time constant and thus outputs a signal according to the angular velocity after the time constant since the angular velocity sensor 40 detects the blur.

As explained in conjunction with the flowchart of FIG. 6, according to the present embodiment, the angular velocity sensor 40 detects the blur occurred during the exposure time T2 shown in FIG. 7. The integration circuit 41 integrates output signals S4 outputted from the angular velocity sensor 40 according to the angular velocity of the blur detected during the exposure time T2 so as to determine an amount of blur representative of the magnitude of the blur at the time of photography. The integration circuit 41 first generates a pulse signal S6 indicative of an integrating duration T3, which has the same pulse width as the pulse signal S5 indicative of a detection duration of blur and is delayed in phase by the corresponding time constant of the angular velocity sensor 40 from the pulse signal S5 in accordance with the pulse signal S5, which has the same pulse width as the exposure time T2 and is synchronized with the exposure time T2. The integration circuit 41 integrates the output signals S4 outputted from the angular velocity sensor 40 by the integrating duration T3 indicated by the pulse signal S6, so that the integration circuit 41 can determine an amount of blur representative of the magnitude of the blur at the time of photography.

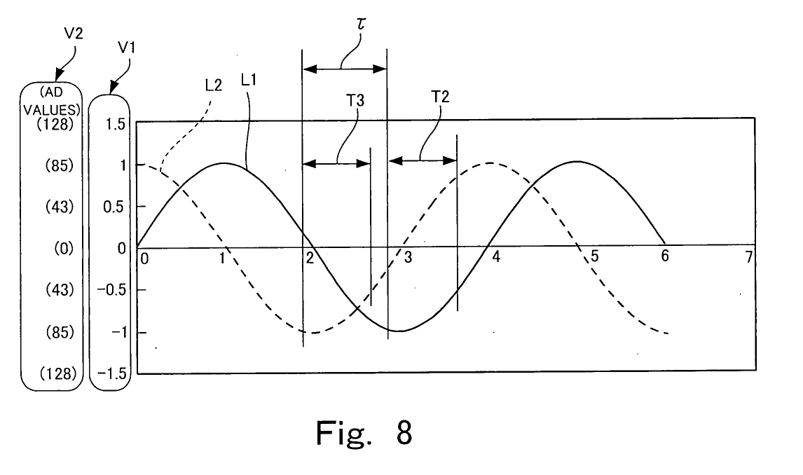

FIG. 8 is a graph showing a relation between the blur detected by the angular velocity sensor and an output signal from the angular velocity sensor.

FIG. 8 shows a curve L1 representative of an angular velocity of a blur detected by the angular velocity sensor 40, and a curve L2 representative of an output signal generated from the angular velocity sensor 40. In FIG. 8, the horizontal axis denotes values associate with time, and the vertical axis denotes values V1 associated with the output signal generated from the angular velocity sensor 40 and values V2 associated with values V1, respectively, which are obtained through an A/D conversion of the absolute value of the output signal generated from the angular velocity sensor 40.

As mentioned above, the angular velocity sensor 40 has a predetermined time constant τ. The angular velocity sensor 40 outputs an output signal represented by the curve L2, which is delayed in phase by the time constant τ with respect to the curve L1, after the time constant τ since the angular velocity sensor 40 detects the blur represented by the curve L1. Accordingly, in order to determine an amount of blur at the time of photography, which is associated with the blur detected by the angular velocity sensor 40 during the exposure time T2 shown also in FIG. 7, there is a need to integrate the output signal generated from the angular velocity sensor 40 during the integrating duration T3, which is delayed in phase by the time constant τ from the exposure time T2. According to the digital camera 10 of the present embodiment, the values V2, which are obtained through an A/D conversion of the absolute value of the output signal generated from the angular velocity sensor 40, are integrated over the integrating duration T3.

As explained in conjunction with FIG. 6 and FIG. 7, according to the present embodiment, an amount of blur at the time of photography is determined in accordance with the blur detected by the angular velocity sensor 40 during the exposure time T2. However, detection duration of blur for determining an amount of blur at the time of photography is not restricted to the exposure time T2. It is acceptable that the detection duration is, for example, a predetermined duration just before the exposure time T2, or a predetermined duration just after the exposure time T2.

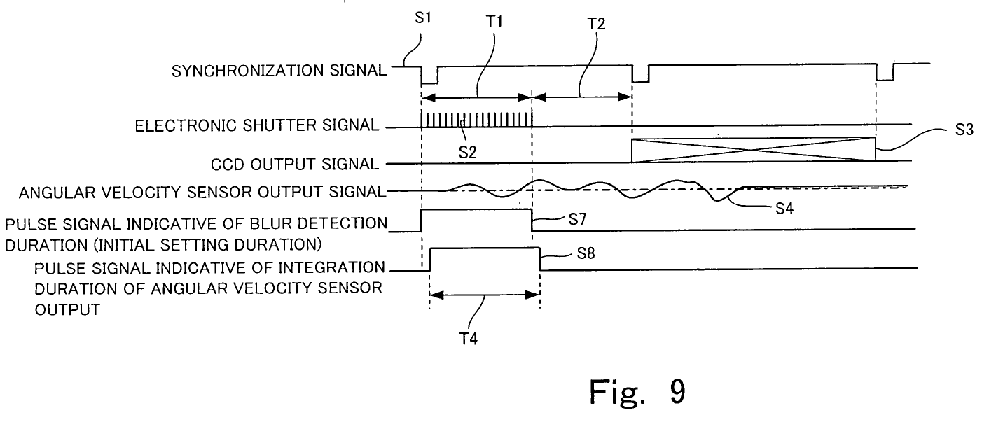

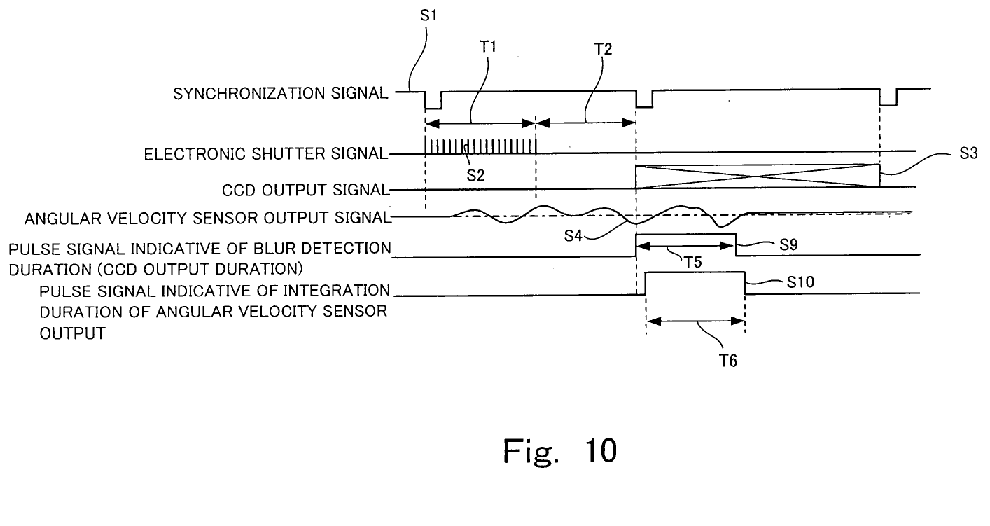

FIG. 9 is a timing chart useful for understanding an example in which an amount of blur at the time of photography is determined during a predetermined duration just before the exposure time, in accordance with a blur detected by the angular velocity sensor. FIG. 10 is a timing chart useful for understanding an example in which an amount of blur at the time of photography is determined during a predetermined duration just before the exposure time, in accordance with a blur detected by the angular velocity sensor.

In FIG. 9 and FIG. 10, the signals, except for the pulse signal indicative of the detection duration in the angular velocity sensor 40 and the pulse signal indicative of the integration duration in the integration circuit 41 to the output signal of the angular velocity sensor 40, are the same as those shown in FIG. 7. Accordingly, in FIG. 9 and FIG. 10, the same parts are denoted by the same reference numbers as those in FIG. 7, and the redundant explanation will be omitted.

First, there will be explained FIG. 9. As mentioned above, according to the example of FIG. 9, an amount of blur at the time of photography is determined during a predetermined duration just before the exposure time T2, in accordance with a blur detected by the angular velocity sensor. In the example of FIG. 9, what is the predetermined duration just before the exposure time T2 is an initial setting duration T1 for the initial setting such as discharge on the CCD 22 just after the depression of the release switch 14 by an operator. Accordingly, in the example of FIG. 9, a pulse signal S7 indicative of detection duration of blur in the angular sensor 40 has a pulse width corresponding to the initial setting duration T1 and is synchronized with the initial setting duration T1. And a pulse signal S8 indicative of integration duration T4 for the output signals of the angular sensor 40 has a pulse width corresponding to the initial setting duration T1 and is delayed in phase by the corresponding time constant of the angular sensor 40 with respect to the initial setting duration T1.

Next, there will be explained FIG. 10. As mentioned above, according to the example of FIG. 10, an amount of blur at the time of photography is determined during a predetermined duration just after the exposure time T2, in accordance with a blur detected by the angular velocity sensor. In the example of FIG. 10, what is the predetermined duration just after the exposure time T2 is a predetermined duration T5 after the initiation of output of the output signals from the CCD 22. Accordingly, in the example of FIG. 10, a pulse signal S9 indicative of detection duration of blur in the angular sensor 40 has a pulse width corresponding to the predetermined duration T5 and is synchronized with the predetermined duration T5. And a pulse signal S10 indicative of integration duration T6 for the output signals of the angular sensor 40 has a pulse width corresponding to the predetermined duration T5 and is delayed in phase by the corresponding time constant of the angular sensor 40 with respect to the predetermined duration T5.

As explained in conjunction with FIG. 7, FIG. 9 and FIG. 10, according to the above-mentioned embodiments, in order to determine an amount of blur at the time of photography, any one is acceptable, as the duration for detecting the blur by the angular sensor 40, which is in the vicinity of the exposure time, for example, the duration coincident with the exposure time, the duration just before the exposure time, or the duration just after the exposure time. Those types of duration make it possible for the angular sensor 40 to completely detect blurs, for example, which will occur on the digital camera when an operator depresses the release button 14, the blurs having an affect on a picture quality of photograph after the printing.

According to the digital camera 10 of the present embodiment, as the detection duration for blurs, there is adopted the duration, which is coincident with the exposure time, as explained referring to FIG. 7. Hereinafter, there will be continued the present embodiment.

According to the present embodiment, as described in conjunction with the flowchart of FIG. 4, there is recorded on the recording media 28 an image file in which information representative of the existence of the occurrence of the large blur at the time of photography is attached to compressed image data obtained through photography.

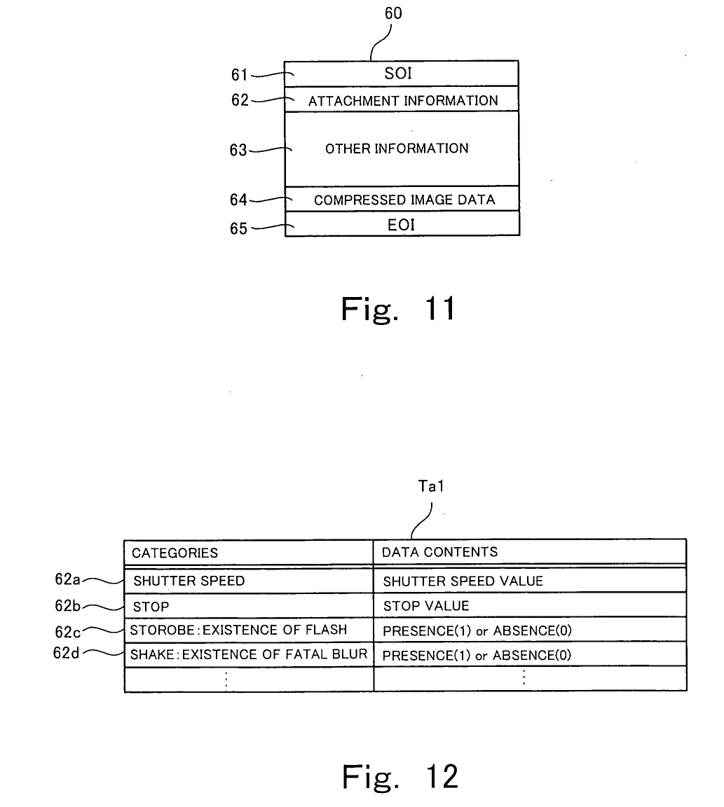

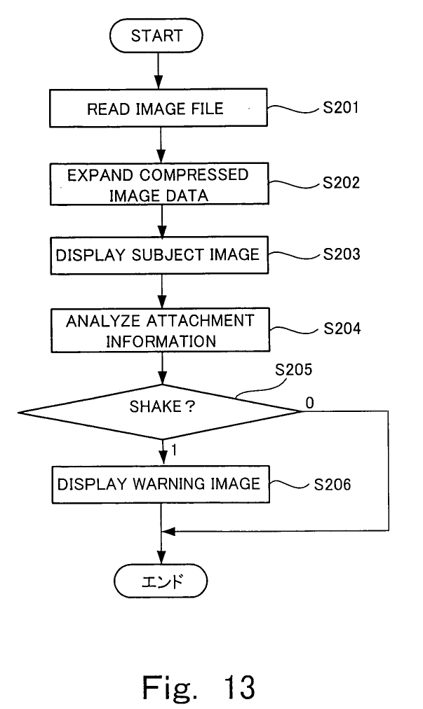

FIG. 11 is a view showing a file structure of an image file. FIG. 12 is a table of a predetermined attached information including blur information, which is attached to compressed image data obtained through photography.

As shown in FIG. 11, an image file 60 associated with once photography for obtaining one photograph comprises: an SOI (Start Of Image) 61 which is a discriminator indicative of a start of the file; an attachment-information 62 representative of photographic condition such as the aperture and the shutter speed, the attachment information 62 including blur information indicative of the existence of the occurrence of the large blur at the time of photography; other information 63 involved in the photography; compressed image data 64 obtained through the photography associated with the image file 60; and an EOI (End Of Image) 65 which is a discriminator indicative of an end of the file. The attachment information 62 shown in FIG. 11 includes, as shown in table Ta1 of FIG. 12, information of categories such as a shutter speed 62a, an aperture 62b, variable 62c representative of the existence of the flash emission, and variable “SHAKE” 62d representative of the existence of a large blur. The respective categories are associated with data contents such as the shutter speed, the aperture, “1” or “0” as values associated with the existence of the flash emission, and “1” or “0” as values associated with the existence of a large blur.

According to the present embodiment, the image file 60 is recorded via the RAM 33 onto the recording media 28, so that an operator can reproduce on the liquid crystal display screen 21 the subject image associated with the image file 60.

And according to the present embodiment, in the event that a large blur occurs on the digital camera 10 at the time of photography for the subject image now to be reproduced, when the subject image is displayed on the liquid crystal display screen 21, the subject image is displayed together with the warning image on the liquid crystal display screen 21.

FIG. 13 is a flowchart useful for understanding a reproduction processing for a subject image to a liquid crystal display screen.

When the reproduction processing starts, first, an image file associated with the subject image now to be reproduced is read from the RAM 33 or the recording media 28 (step S201). Next, there is executed an extension of the compressed image data included in the image file read in the step S201 (step S202). The subject image represented by image data obtained through the extension is displayed on the liquid crystal display screen 21 (step S203). Next, there is executed analysis of the attachment information included in the image file read in the processing of the step S201 (step S204). In accordance with the attachment information, it is discriminated whether the variable “SHAKE” indicative of the existence of a large blur at the time of photography is set up to “1” indicating the presence of a large blur or set up to “0” indicating the absence of a large blur (step S205). In the discrimination processing of the step S205, when it is discriminated that the variable “SHAKE” is set to “1”, a warning image G2 shown in FIG. 5 is displayed on the liquid crystal display screen 21 together with the subject image that is already displayed on the liquid crystal display screen 21 (step S206). Thus process is terminated. In the discrimination processing of the step S205, when it is discriminated that the variable “SHAKE” is set to “0”, only the subject image, which is already displayed, is displayed on the liquid crystal display screen 21, and the process is terminated.

As described above, according to the digital camera 10 of the present embodiment, it is possible for an operator to confirm on the liquid crystal display screen 21 the existence of the occurrence of the large blur at the time of photography, which has an effect on the picture quality of the subject image, before printing a photograph. In other words, it is possible for the operator to know deterioration of the picture quality of the subject image, which will occur owing to the blur of the main frame of the device or apparatus, before printing a photograph.

According to the present embodiment, as the warning section referred to in the present invention, there is raised an example in which a predetermined warning image is displayed on the liquid crystal display screen. However, the present invention is not restricted to the embodiments. It is acceptable that the warning section referred to in the present invention is, for example, when a large blur occurs at the time of photography, one in which warning is displayed with turning on a light of a display unit such as a LED when the subject image based on the image data obtained through the photography is displayed on the liquid crystal display screen, or alternatively one in which warning is issued with voice such as warning sound and warning message when the subject image based on the image data obtained through the photography is displayed on the liquid crystal display screen.

Further, according to the present embodiment, as the image taking apparatus of the present invention, there is raised a digital camera by way of example. The image taking apparatus of the present invention is not restricted to the embodiments. It is acceptable that the image taking apparatus of the present invention is, for example, a portable telephone having a camera function, which comes in to wide use recently.

As mentioned above, according to the image taking apparatus of the present invention, it is possible for an operator to easily know an occurrence of deterioration of picture quality of the subject image, which will occur owing to the blur of the main frame of the device or apparatus, before printing a photograph.

While the present invention has been described with reference to the particular illustrative embodiments, it is not to be restricted by those embodiments but only by the appended claims. It is to be appreciated that those skilled in the art can change or modify the embodiments without departing from the scope and sprit of the present invention.

1. An image taking apparatus that catches subject light, so that image data representative of a subject image is created, the image taking apparatus comprising:
a blur detection section that detects a blur of the image taking apparatus itself through once image taking operation to obtain a subject image;
a display section having a display screen, which displays on the display screen the subject image based on the image data obtained through the image taking operation; and
a warning section that issues a warning of occurrence of a blur, when the subject image based on the image data obtained through the image taking operation is displayed on the display screen, in the event that a magnitude of the blur detected by the blur detection section at the time of the image taking operation is larger than a predetermined magnitude.

2. An image taking apparatus according to claim 1, wherein the warning section issues a warning of occurrence of a blur in such a manner that a predetermined warning image is displayed on the display screen, when the subject image based on the image data obtained through the image taking operation is displayed on the display screen, in the event that a magnitude of the blur detected by the blur detection section at the time of the image taking operation is larger than a predetermined magnitude.

3. An image taking apparatus according to claim 1, wherein the display section displays the subject image based on the image data obtained through the image taking operation at time of the end of the image taking operation.

4. An image taking apparatus according to claim 1, wherein the image taking apparatus further comprises:
an information attaching section that attaches blur information representative of an occurrence of a blur to the image data obtained through the image taking operation in the event that a magnitude of the blur detected by the blur detection section at the time of the image taking operation is larger than a predetermined magnitude;
a recording section that records the image data onto a predetermined recording medium, and the blur information attached to the image data as well onto the recording medium in the event that the blur information is attached to the image data by the information attaching section; and
a reading section that reads the image data from the recording medium,
wherein the a display section displays on the display screen the subject image represented by the image data read by the reading section from the recording medium, and
the warning section causes a predetermined warning image to be displayed on the display screen, when the subject image based on the image data is displayed on the display screen, in the event that the blur information is attached to the image data read by the reading section from the recording medium.
